(19) United States
(12) Patent Application Publication
(10) Pub. No.: US 2007/0279439 A1
(43) Pub. Date: Dec. 6, 2007

(54) Method and device for region-based bitblt with clipping-in or clipping-out

(76) Inventors: Chou-Liang Tsai, Hsinhua (TW); Wei-Pung Tsay, Hsinhua (TW); Tzung-Ren Wang, Hsinhua (TW)

Correspondence Address: J.C. Patents, Inc., Suite 250, 4 Venture, Irvine, CA, 92618, US

(21) Appl. No.: 11/448,452

(22) Filed: Jun. 6, 2006

(51) Int. Cl. G09G 5/00

(52) U.S. Cl. 345/682

(57) ABSTRACT

A device and method for region-based bitblt with clipping-in or clipping-out. Data within a source bitblt region at a first source base address is selectively moved to a destination bitblt region at a first destination base address. One or more bitblt commands are produced if one or more regions within the source bitblt region are to be moved. The bitblt commands are temporarily stored in a plurality of buffer memories. Each of the bitblt commands are decoded into a second source base address, a second destination base address, a height parameter, and a width parameter. The regions to be moved are bitblted to the destination bitblt region based on the second source base address, the second destination base address, and the corresponding height and width parameters.

### BACKGROUND OF THE INVENTION

1. Field of Invention

The present invention relates to a method and device for region-based bitblt (bit block transfer) with clipping-in or clipping-out.

2. Description of Related Art

In two-dimensional image display, bitblt (bit block transfer) and clipping are essential functions. Bitblt refers to moving data at a given address of a memory to another address. As shown in FIG. 1a, data at a source base address src_ba of the memory is moved to a destination base address dst_ba through the bitblt function. FIG. 1b shows the image displayed on a screen 120 after the bitblt function is executed. Generally, the parameters used in the bitblt function include the source base address, the destination base address, and the width and height of the image.

Moreover, it is possible to execute a clipping function simultaneously with the bitblt function. The clipping function may be a clipping-in function or a clipping-out function. Referring to FIG. 2a, it shows a source bitblt region at a source base address src_ba, a destination bitblt region at a destination base address dst_ba and a clipping window within the destination bitblt region. FIG. 2b shows the result after the bitblt function is executed. Clipping-in refers to displaying the destination bitblt region inside of the clipping window. Clipping-out refers to displaying the destination bitblt region outside of the clipping window. FIG. 2c shows the resultant image after the bitblt function is executed simultaneously with the clipping-in function (hereinafter, referred as “bitblt with clipping-in”); and FIG. 2d shows the resultant image after the bitblt function is executed simultaneously with the clipping-out function (hereinafter, referred as “bitblt with clipping-out”).

In the conventional art, in bitblt with clipping-in or bitblt with clipping-out, each point (i.e. each pixel) within the source bitblt region must be checked to determine whether it is to be moved and displayed. This conventional art is called pixel-based bitblt with clipping-in or clipping-out.

During the bitblt with clipping-in, each point within the source bitblt region should be checked whether it is to be placed inside of the clipping window within the destination bitblt region. If yes, this point is bitblted; otherwise, this point is not bitblted.

Similarly, during the bitblt with clipping-out, each point within the source bitblt region should be checked whether it is to be placed outside of the clipping window within the destination bitblt region. If yes, this point is bitblted; otherwise, this point is not bitblted.

However, such a pixel-based bitblt with clipping-in or clipping-out has an unfavorable performance and high complexity.

Therefore, the present invention provides a method and device for region-based bitblt with clipping-in or clipping-out, which has a lower complexity and better performance, without additional increase in circuit area.

### SUMMARY OF THE INVENTION

To achieve the above and other objects, the present invention provides a device and method for region-based bitblt with clipping-in or clipping-out. Data within a source bitblt region at a first source base address is selectively moved to a destination bitblt region at a first destination base address. One or more bitblt commands are produced if one or more regions within the source bitblt region are to be moved. The bitblt commands are temporarily stored in a plurality of buffer memories. Each of the bitblt commands are decoded into a second source base address, a second destination base address, a height parameter, and a width parameter. The regions to be moved are bitblted to the destination bitblt region based on the second source base address, the second destination base address, and the corresponding height and width parameters.

When bitblt with clipping-in need to be performed, each region within the source bitblt region that is inside of the clipping window, if any, is moved; and the number of the region to be moved may be 1 or 0. When bitblt with clipping-out need to be performed, each region within the source bitblt region that is outside of the clipping window, if any, is moved; and the number of the region to be moved may be 4, 3, 2, 1 or 0.

In order to the make the aforementioned and other objects, features and advantages of the present invention comprehensible, preferred embodiments accompanied with figures are described in detail below.

### BRIEF DESCRIPTION OF THE DRAWINGS

FIG. 1a shows a schematic view of a bitblt function performed on data of the memory.

FIG. 1b shows the resultant image after the bitblt function is executed.

FIG. 2a shows a source bitblt region, a destination bitblt region and a clipping window.

FIG. 2b shows the resultant image after the bitblt function is performed.

FIG. 2c shows the resultant image after the bitblt with clipping-in function is executed.

FIG. 2d shows the resultant image after the bitblt with clipping-out function is executed.

FIGS. 3a to 3z and FIGS. 3a-1 to 3j-1 show position relationships between the destination bitblt region and the clipping window.

FIG. 4 shows the position codes, the number of the region to be moved, as well as the coordinates of the region to be moved during bitblt with clipping-in.

FIG. 5 shows the position codes, the number of the region(s) to be moved, as well as the coordinates of the region(s) to be moved during bitblt with clipping-out.

FIG. 6 shows a circuit block view for bitblt with clipping-in or clipping-out according to a first embodiment of the present invention.

FIG. 7 shows a schematic view about how the processor generates bitblt commands according to the first embodiment.

FIG. 8 shows a schematic block view of the command engine according to the first embodiment of the present invention.

FIG. 9 shows a finite state machine (FSM) according to the first embodiment of the present invention.

FIG. 10 shows a finite state machine (FSM) according to a second embodiment of the present invention.

FIG. 11 shows a schematic view of the second embodiment of the present invention.

### DESCRIPTION OF EMBODIMENTS

In order to overcome the disadvantages of the conventional art, the region-based bitblt with clipping-in or clipping-out is proposed. When bitblt with clipping-in need to be performed, each region within the source bitblt region that is to be placed inside of the clipping window, if any, is moved; and the number of the region to be moved may be 1 or 0. When bitblt with clipping-out need to be performed, each region within the source bitblt region that is to be placed outside of the clipping window, if any, is moved; and the number of the region to be moved maybe 4, 3, 2, 1 or 0.

In the following descriptions, the source bitblt region, the destination bitblt region, the clipping window, and the region(s) to be moved are all rectangle-shaped for example and the invention is not limited thereto. For brief illustration, each of the rectangular regions is represented by the coordinates at the upper-left corner and the lower-right corner. Here, the coordinate at the upper-left corner of the clipping window is defined as (lt, tp), while the coordinate at the lower-right corner of the clipping window is defined as (rt, bt). The coordinate at the upper-left corner of the destination bitblt region is defined as (x0, y0), while the coordinate at the lower-right corner of the destination bitblt region is defined as (x0+W,y0+H). W and H are width and height of the destination bitblt region.

For the purpose of defining the position relationships between the destination bitblt region and the clipping window, four position codes B1, B0, A1, and A 0 are defined below. The values of the position codes can be L, M, or H.

| | |
|---|---|
| B1 = L | lf < x0 |
| B1 = M | x0 ≦ lf ≦ x0 + W |
| B1 = H | x0 + W < lf |
| B0 = L | rt < x0 |
| B0 = M | x0 ≦ rt ≦ x0 + W |
| B0 = H | x0 + W < rt |
| A1 = L | tp < y0 |
| A1 = M | y0 ≦ tp ≦ y0 + H |
| A1 = H | y0 + H < tp |
| A0 = L | bt < y0 |
| A0 = M | y0 ≦ bt ≦ y0 + H |
| A0 = H | y0 + H < bt |

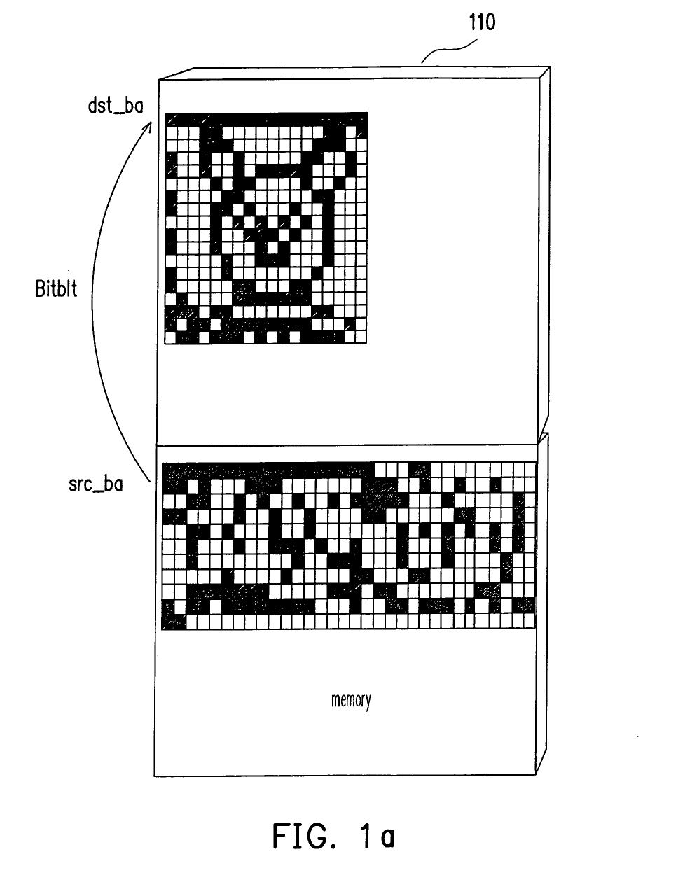

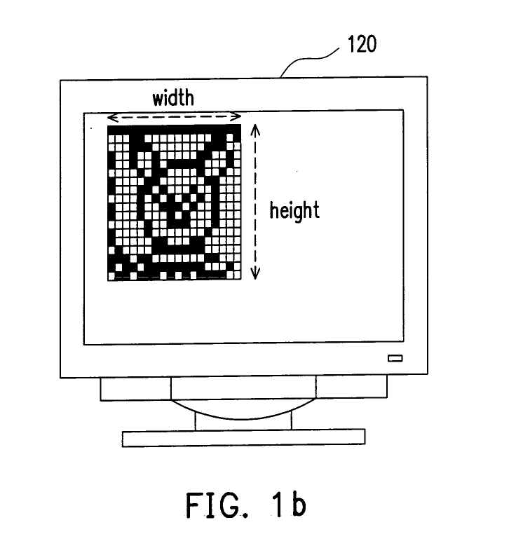

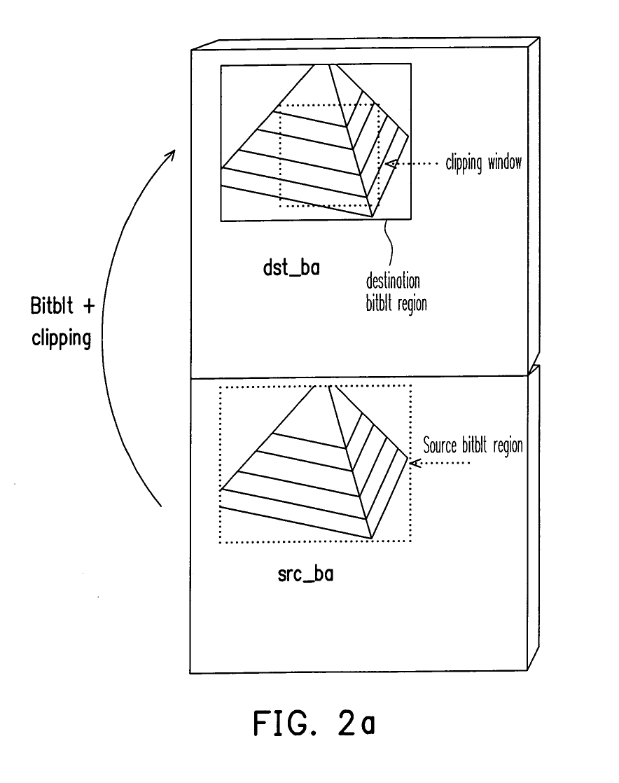

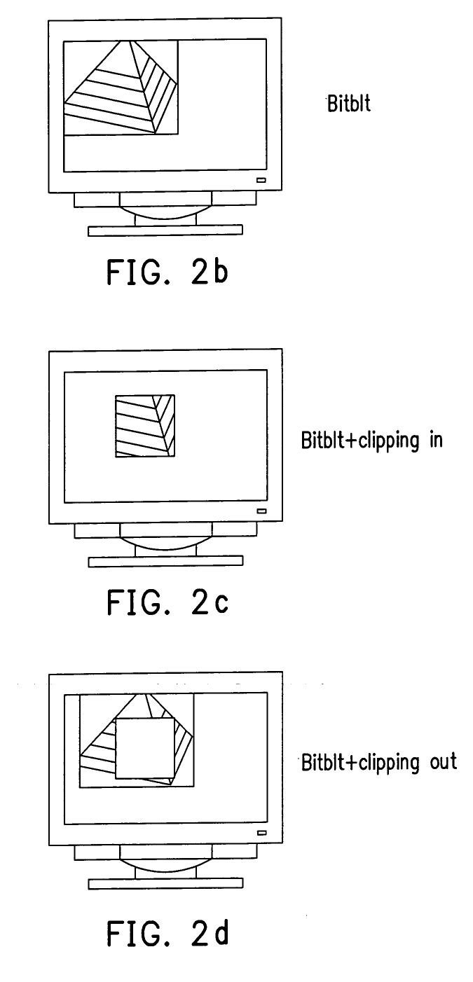

Refer to FIGS. 3a to 3z and FIGS. 3a-1 to 3j-1 for a clear view of the position relationships between the destination bitblt region and the clipping window. In FIGS. 3a to 3z and FIGS. 3a-1 to 3j-1, the region enclosed by a solid line is the destination bitblt region, while the region enclosed by a dashed line is the clipping window. In FIGS. 3a to 3z and FIGS. 3a-1 to 3j-1, the borderline(s) of the destination bitblt region or the clipping window may not be displayed when overlapped, but the positions of the destination bitblt region or the clipping window still can be deduced from the respective upper-left coordinate and the lower-right coordinate. Moreover, in FIGS. 3a to 3z and FIGS. 3a-1 to 3j-1, only relative positions of the destination bitblt region and the clipping window are shown, and relative sizes of the destination bitblt region and the clipping window are not limited thereto.

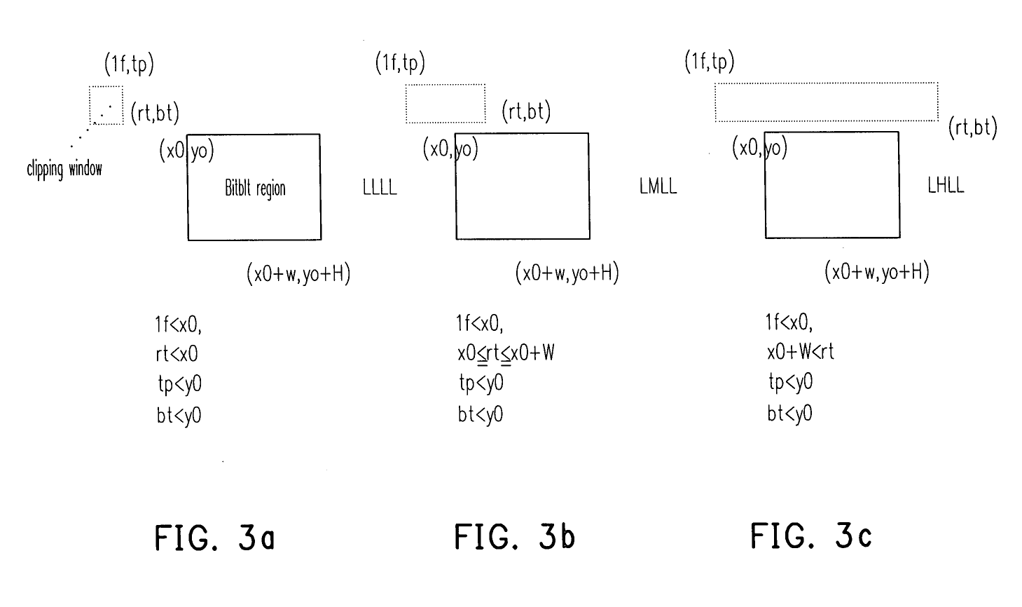

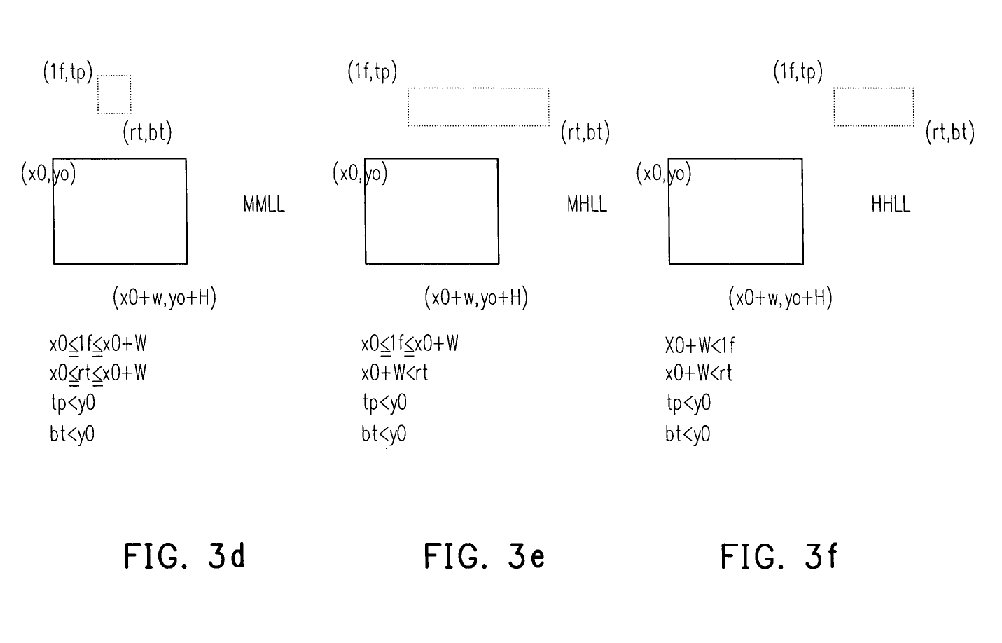

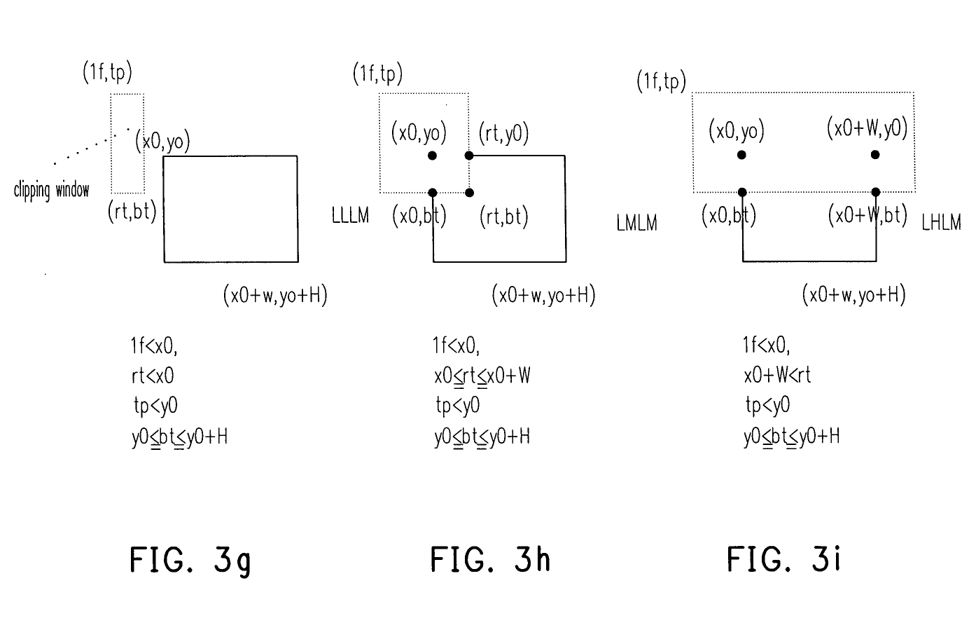

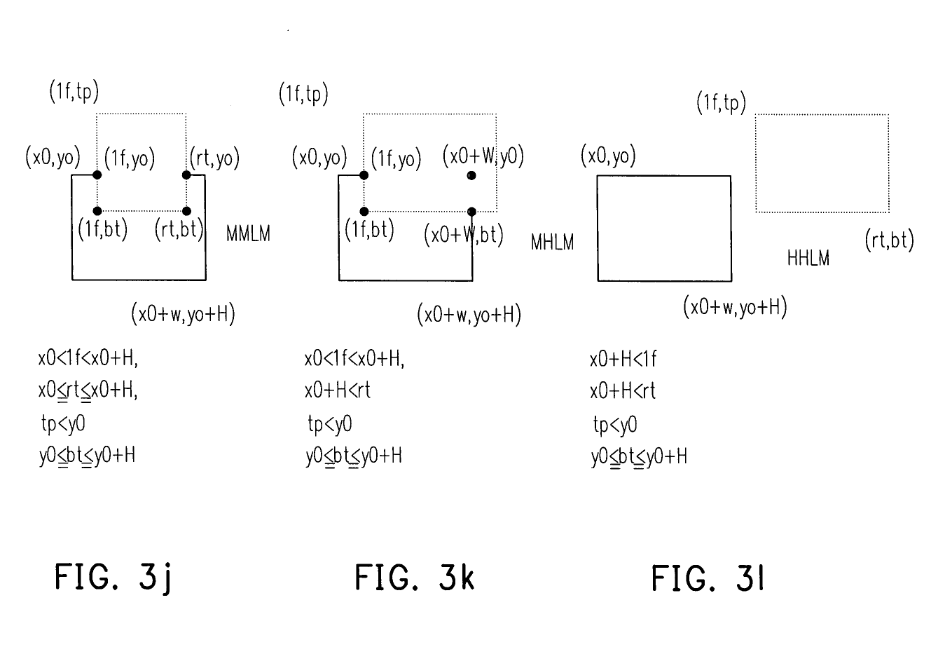

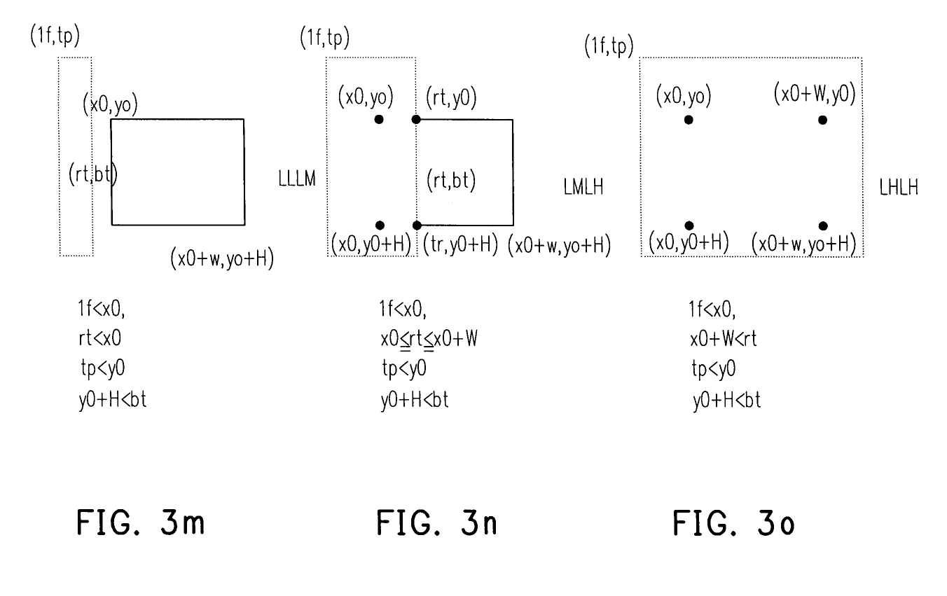

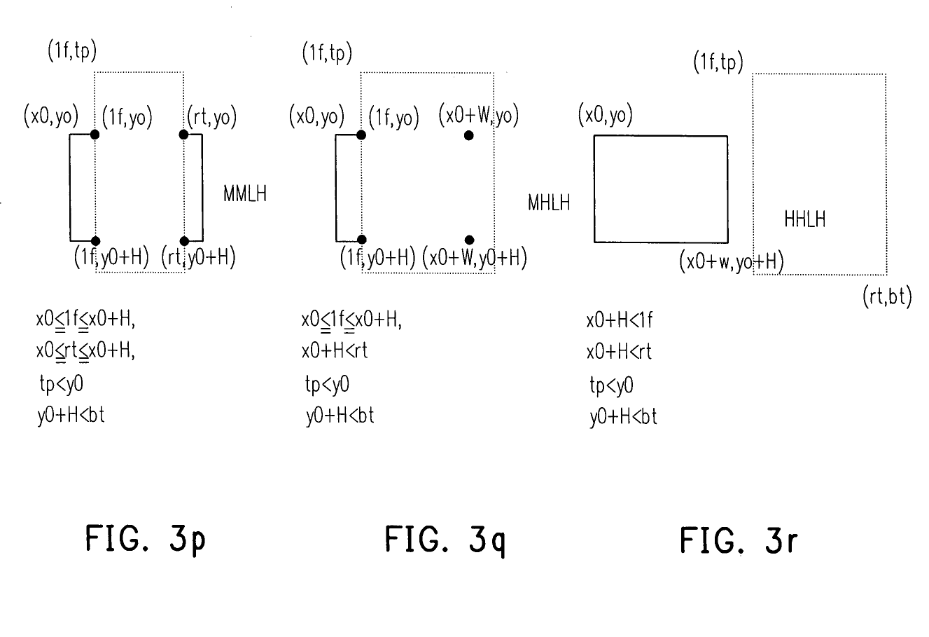

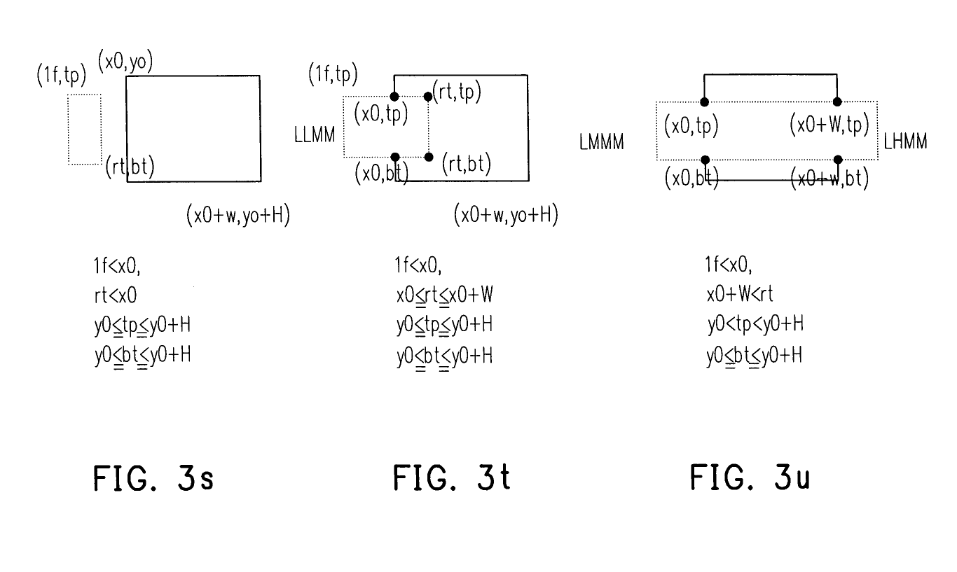

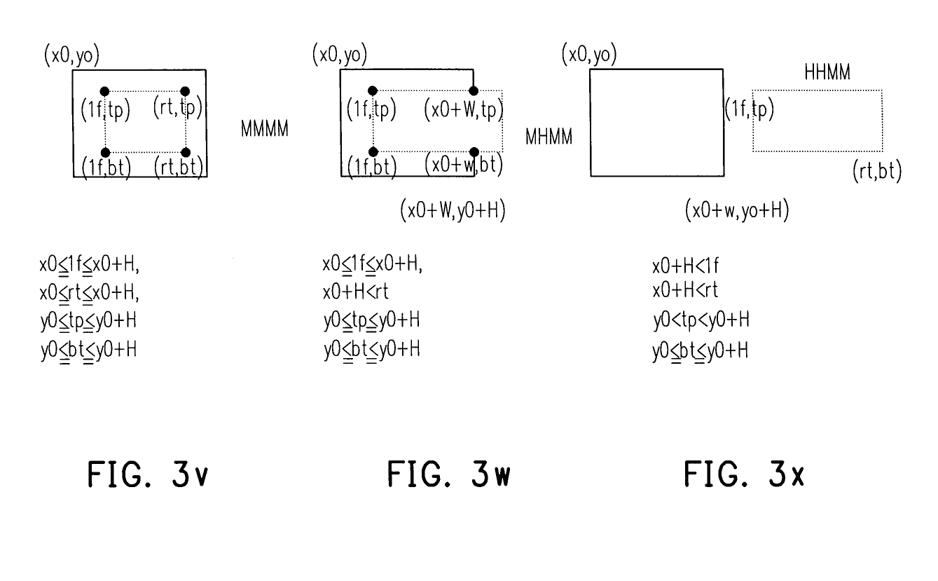

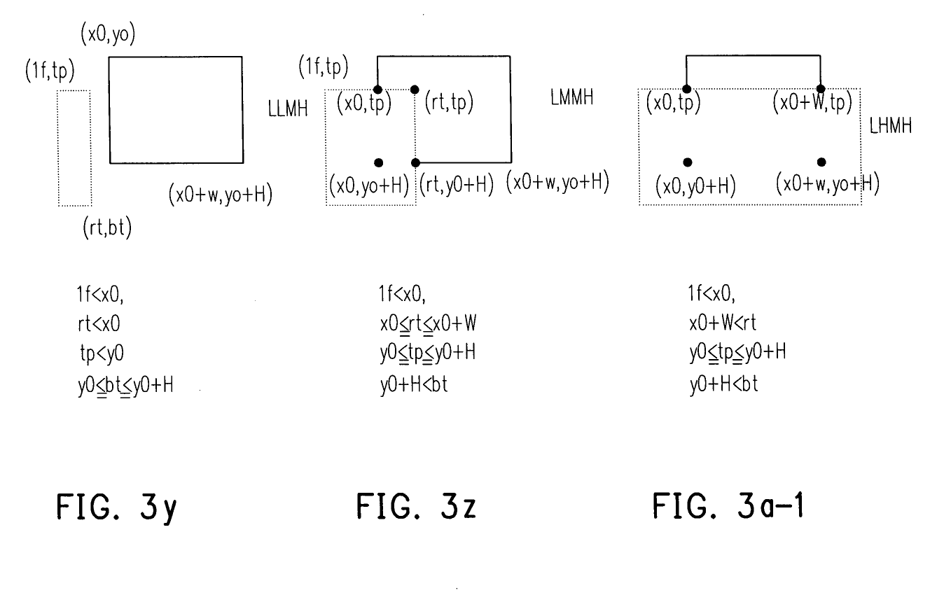

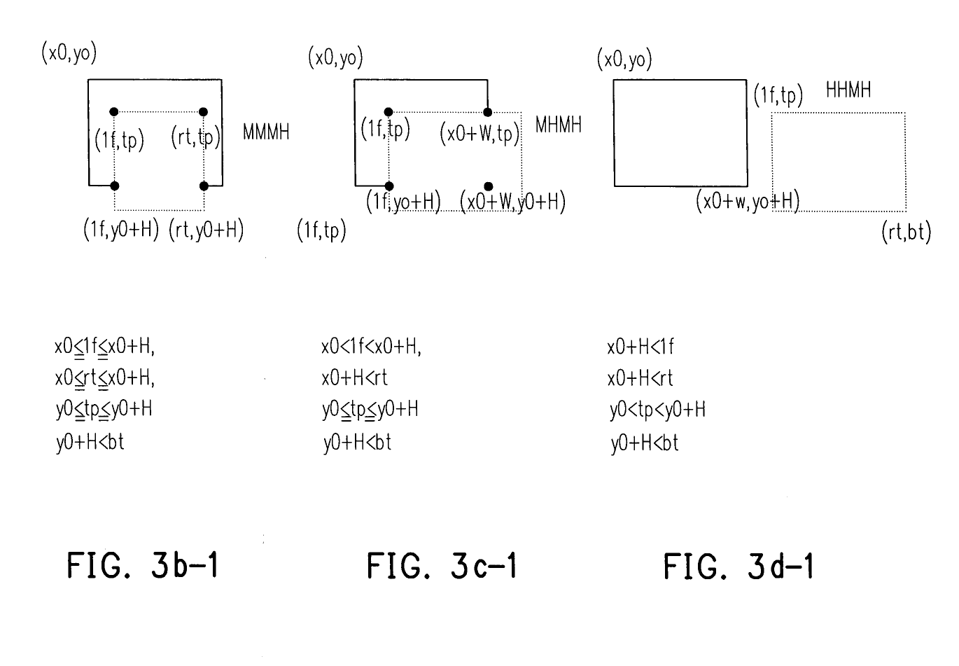

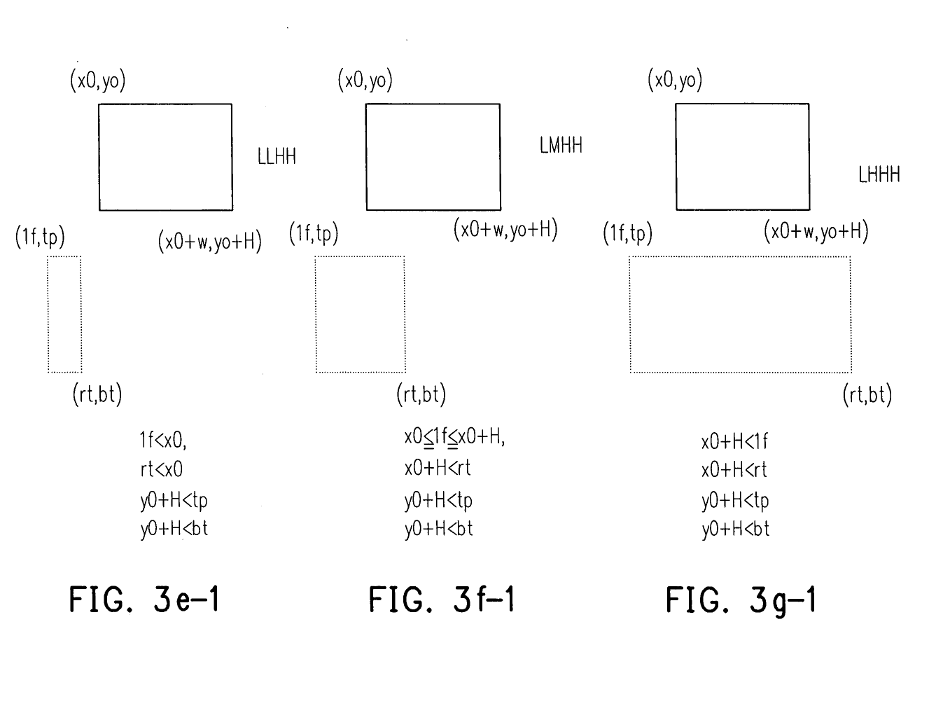

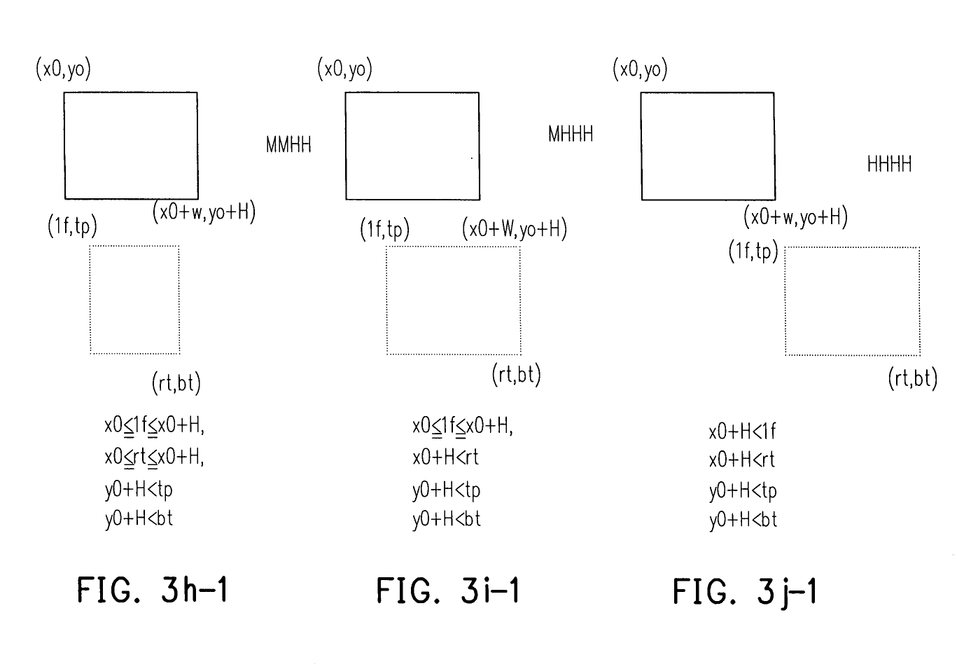

It can be seen from FIGS. 3a to 3z and FIGS. 3a-1 to 3j-1 that the number of the region to be moved is between either 0 or 1 during bitblt with clipping-in. Taking FIG. 3a as an example, there is no need to move any region during bitblt with clipping-in, because the destination bitblt region is outside of the clipping window. Taking FIG. 3h as an example, there is one region to be moved during bitblt with clipping-in, that is, the region specified by the coordinates (x0,y0) and (rt,bt).

It can also be seen from FIGS. 3a to 3z and FIGS. 3a-1 to 3j-1 that the number of the region(s) to be moved is 0, 1, 2, 3 or 4 during bitblt with clipping-out. Taking FIG. 3o as an example, there is no need to move any region during bitblt with clipping-out. Taking FIG. 3n as an example, there is one region to be moved during bitblt with clipping-out, that is, the one specified by the coordinates (rt,y0) and (x0+W,y0+H). Taking FIG. 3u as an example, there are two regions to be moved during bitblt with clipping-out, that is, the regions respectively specified by the coordinates (x0,y0) and (x0+W,tp), and the coordinates (x0,bt) and (x0+W,y0+H). Taking FIG. 3j as an example, there are three regions to be moved during bitblt with clipping-out, that is, the regions respectively specified by the coordinates (x0,y0) and (lf, bt), the coordinates (rt,y0) and (x0+W,bt), and the coordinates (x0,bt+1) and (x0+W,y0+H). Taking FIG. 3v as an example, there are four regions to be moved during bitblt with clipping-out, that is, the regions respectively specified by the coordinates (x0,y0) and (x0+W,tp), the coordinates (x0,tp+1) and (lf,bt), the coordinates (rt,tp+1) and (x0+W,bt), and the coordinates (x0,bt+1) and (x0+W,y0+H).

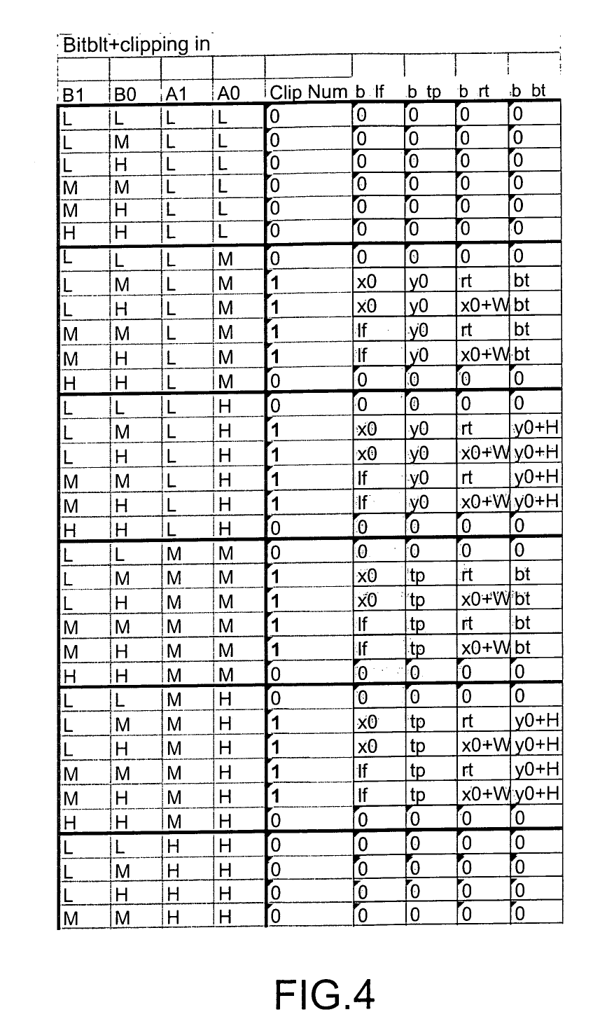

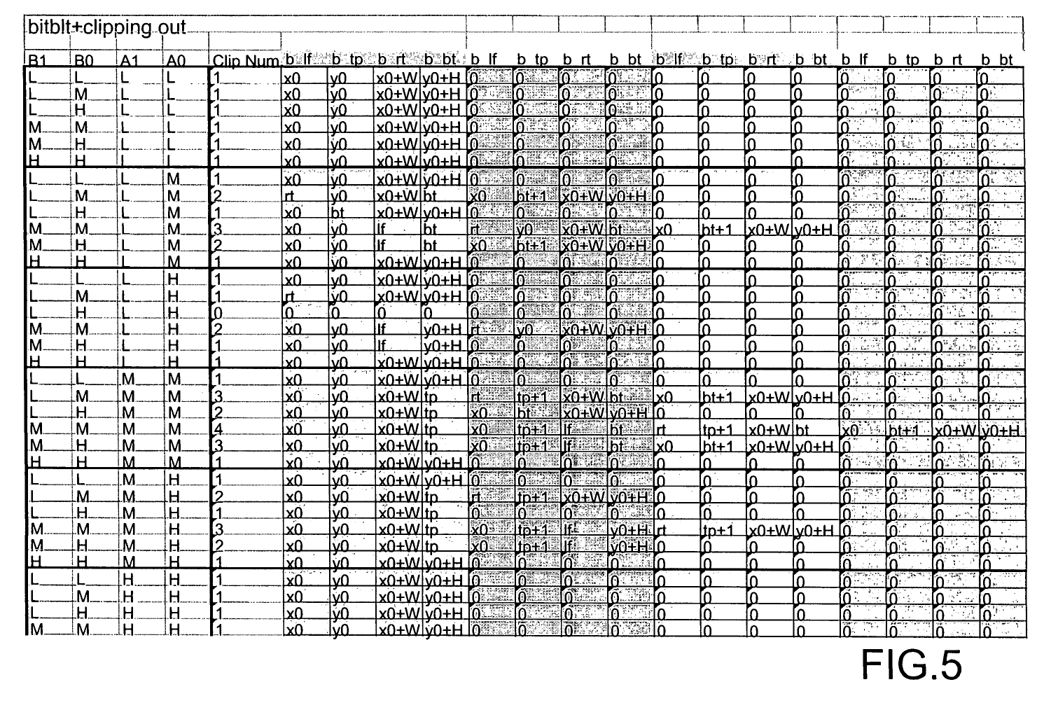

Refer to FIG. 4 for a clear view of the position codes, the number of the region needing to be moved, as well as the upper-left and the lower-right corner coordinates of the region needing to be moved during bitblt with clipping-in. In FIG. 4, the quantity parameter clip₋num represents the number of the region needing to be moved, which is either 1 or 0. b_lf and b_tp represent the upper-left corner coordinate of the region needing to be moved; b_rt and b_bt represent the lower-right corner coordinate of the region needing to be moved. It should be noted that the values of b_lf, b_tp, b_rt, and b_bt are set as 0 when there is no region needing to be moved.

Refer to FIG. 5 for a clear view of the position codes, the number of the regions needing to be moved, as well as the upper-left and the lower-right corner coordinates of the regions needing to be moved during bitblt with clipping-out. In FIG. 5, clip₋num represents the number of the regions needing to be moved, which is 0, 1, 2, 3 or 4. b_lf and b_tp represent the upper-left corner coordinates of the regions needing to be moved; b_rt and b_bt represent the lower-right corner coordinates of the regions needing to be moved. It should be noted that the values of b_lf, b_tp, b_rt, and b_bt are set to be 0 when there is no region needing to be moved.

The first and second embodiments of the present invention will be described in the following illustrations.

### First Embodiment

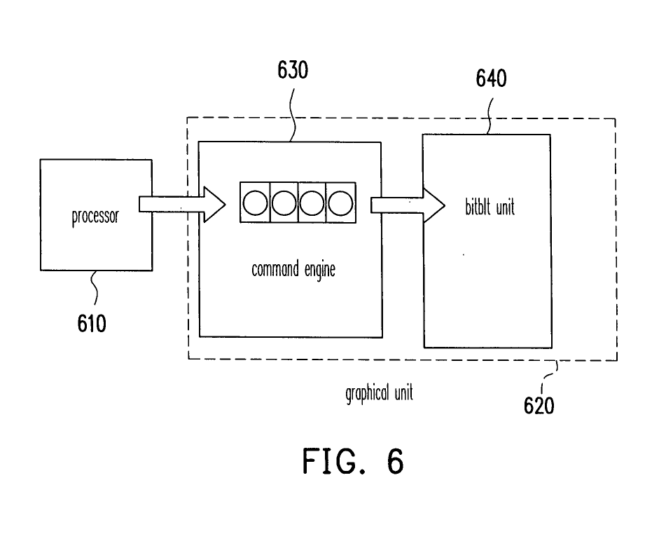

Referring to FIG.6, which shows a circuit block diagram for bitblt with clipping-in or clipping-out according to the first embodiment of the present invention. The circuit in the first embodiment of the present invention includes a processor 610, a graphical unit 620, a command engine 630, and a bitblt unit 640. In FIG. 6, the processor 610 is, for example, a computer's CPU (central processing unit). The processor 610 is used to produce the commands and send the commands to the command engine 630. Once receiving the commands from the processor 610, the command engine 630 will multiplex, register, decode the commands, and then send the resultant parameters to the bitblt unit 640. The bitblt unit 640 then will perform the bitblt with clipping-in or clipping-out function based on the resultant parameters sent from the command engine 630. As such, the graphical unit 620 will display an image resulted from the bitblt with clipping-in or clipping-out function on a display (such as the computer's monitor).

It will be explained in the following descriptions about how the processor 610 is used to produce the commands. It can be known from the above analysis that the maximum number of the regions to be moved is 1 during bitblt with clipping-in and 4 during bitblt with clipping-out. Therefore, the depth of the command engine 630 is 4 (i.e. 4 buffer memories included therein) in the present embodiment, so that four commands can be stored therein in case 4 regions need to be bitblted. Furthermore, each of the commands is used for one region to be moved.

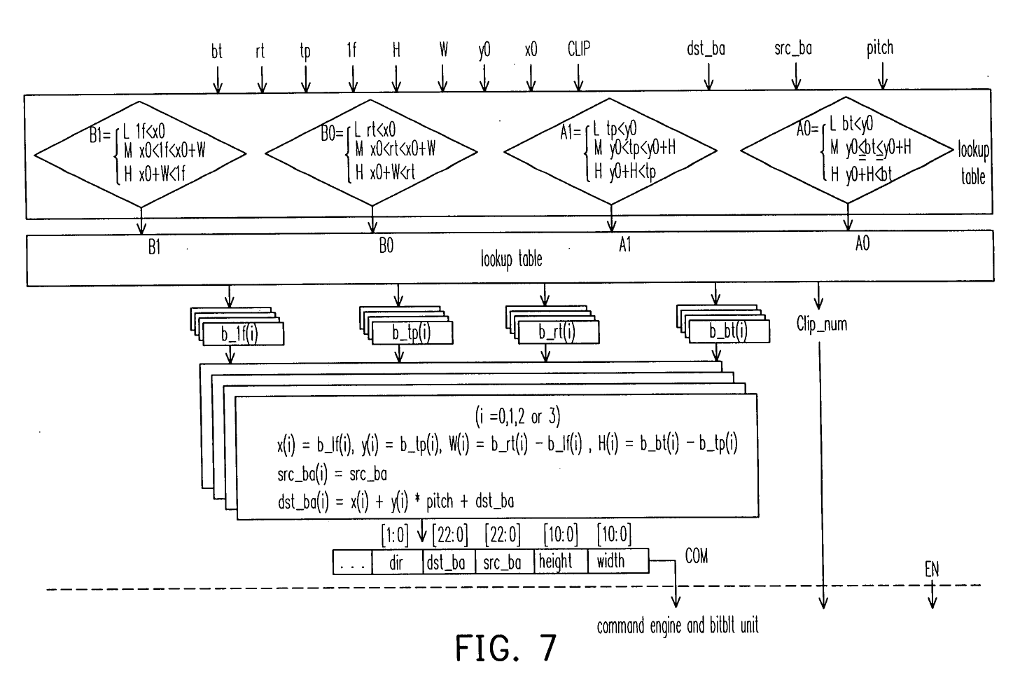

Referring to FIG.7, which shows a schematic view about how the processor is used to produce the commands in the first embodiment. In FIG. 7, the parameters If and tp represent the upper-left corner coordinate of the clipping window; and the parameters rt and bt represent the lower-right corner coordinate of the clipping window. The parameters x0 and y0 represent the upper-left corner coordinate of the destination bitblt region; and the parameters H and W represent the height and width of the destination bitblt region. The clipping type parameter CLIP represents clipping-in or clipping-out, for example, when the clipping type parameter CLIP is logic 1, it indicates clipping-in; otherwise, clipping-out. The parameter dst_ba represents the destination base address, and the parameter src_ba represents the source base address.

The position codes B1, B0, A1, and A0 are determined based on the relationships among the parameters lf, tp, rt, bt, x0, y0, H, and W. Since it can be known from the above about how to determine the position codes B1, B0, A1, and A0, no further details will be provided here. After the position codes B1, B0, A1, and A0 are determined, the upper-left and lower-right corner coordinates of the regions to be moved can be obtained based on the lookup table from FIG. 4 (in case of bitblt with clipping-in) or FIG. 5 (in case of bitblt with clipping-out). In FIG. 7, the meanings of b_lf, b_tp, b_rt, and b_bt are similar to that in FIG. 4 or FIG. 5. Since there may be up to 4 regions to be moved, 4 sets of b_lf, b_tp, b_rt, and b_bt, i.e., b_lf(0)-b_lf(3), b_tp(0)-b_tp(3), b_rt(0)˜b_rt(3), and b_bt(0)˜b bt(3), are used to represent the coordinates for each of the region(s) to be moved, respectively.

Subsequently, the parameters x(i), y(i), W(i), and H(i) are obtained based on b_lf(i), b_tp(i), b_rt(i), and b_bt(i) (i=0, 1, 2 or 3). x(i) and y(i) represent the upper-left corner coordinate of the i-th region to be moved; W(i) and H(i) represent the width and height of the i-th region to be moved.

x(i)=b_{—}lf(i)

y(i)=b_{—}tp(i)

W(i)=b_{—}rt(i)-b_{—}lf(i)

H(i)=b_{—}bt(i)-b_{—}tp(i) (1)

Furthermore, the source base address src_ba(i) of the i-th region to be moved is still src_ba, but the destination base address dst_ba(i) thereof is expressed as follows:

dst_{—}ba(i)=x(i)+y(i)*pitch+dst_{—}ba (2)

wherein the parameter pitch specifies the width of the source/destination data in terms of the number of bytes per scan line's worth of source/destination data.

Thus, the parameters x(i), y(i), W(i), H(i), src_ba(i), dst_ba(i) and a direction parameter dir of the i-th region to be moved will be encoded as the i-th bitblt command, wherein the direction parameter dir is used to prevent error overwriting during bitblt with clipping-in or clipping-out.

Additionally, it can be known from the lookup tables that the parameter clip₋num represents the number of the regions to be moved, and its value is between 0 and 4. If the parameter clip_num is not 0, then bitblt with clipping-in or clipping-out is needed, so that the enable signal EN can be enabled. Otherwise, if clip₋num is 0, then bitblt with clipping-in or clipping-out is not needed, so that the enable signal EN can be disabled.

In view of the above, the processor can encode the parameters bt, rt, tp, lf, x0, y0, H, W, CLIP, dst_ba, src_ba, and pitch into several (4 at most, 0 at least) bitblt commands, quantity parameters clip-num, and an enable signal EN, and then send them to the command engine and the bitblt unit.

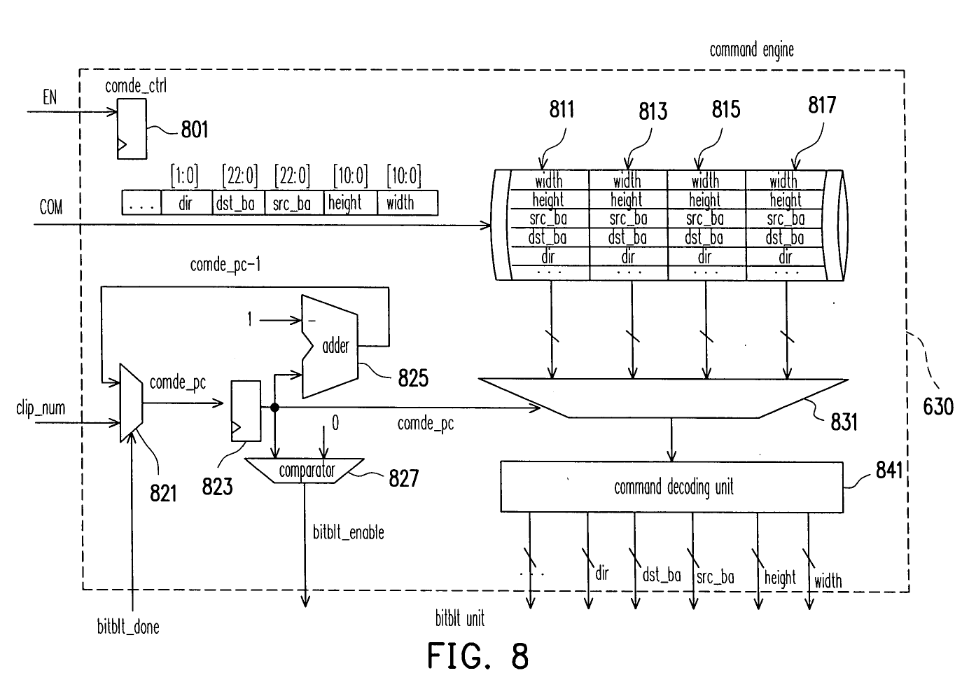

FIG. 8 shows a block schematic view of the command engine according to the first embodiment of the present invention. As shown in FIG. 8, the command engine 630 includes a flip-flop 801, buffer memories 811-817, a multiplexer 821, a flip-flop 823, an adder 825, a comparator 827, a multiplexer 831, and a command decoding unit 841. The command engine 630 receives the enable signal EN, bitblt commands COM, and the parameter clip₋num sent by the processor 610.

The flip-flop 801 receives the enable signal EN as a control signal cmode_ctrl. The control signal cmode_ctrl is used to control whether the command engine 630 operates.

The buffer memories 811, 813, 815 and 817 receive several commands COM sent by the processor 610. Each bitblt command COM is stored in one of the buffer memories. The format of the bitblt command COM has been described above.

The multiplexer 821 is controlled by a signal bitblt_done returned from the bitblt unit 640. Once the bitblt unit 640 finishes a given bitblt command, it returns a valid signal bitblt_done. When the signal bitblt_done is valid, the parameter cmode_pc−1 will be output by the multiplexer 821; otherwise, the parameter clip-num will be output by the multiplexer 821. The output signal of the multiplexer 821 is as the parameter cmode_pc.

The flip-flop 823 is used to register the parameter cmode_pc output by the multiplexer 821, and then output it to the adder 825, the comparator 827, and the multiplexer 831.

The adder 825 subtracts 1 from the parameter cmode_pc, and then returns the resulting value cmode_pc−1 to the multiplexer 821. With the operation of the adder 825, when there are several (more than 1) bitblt commands and the bitblt unit finishes a given command, the multiplexer 831 selects the bitblt command stored in another buffer memory. In other words, the quantity parameter cmode_pc is subtracted by 1, so that another buffer memory can be selected.

The comparator 827 is used to compare the parameter cmode_pc and a reference value, for example, 0. If the value of the parameter cmode_pc is not 0, then a valid enable signal bitblt_enable is output to enable the bitblt unit 640. When the value of the parameter cmode_pc is not 0, it indicates not all of the bitblt commands have been executed. Otherwise, if the value of the parameter cmode_pc is 0, then an invalid enable signal bitblt_enable is output to disable the bitblt unit 640. When the value of the parameter cmode_pc is 0, it indicates all of the bitblt commands have been executed or there is no bitblt command to be executed.

The multiplexer 831 selects a bitblt command stored in one of the buffer memories 811-817 based on the parameter cmode_pc. For example, when the parameter cmode_pc is 4, the buffer memory 817 is selected and so on.

The command decoding unit 841 decodes the bitblt commands sent by the multiplexer 831 into the parameters dir, dst_ba, src_ba, height, and width, and then sends them to the bitblt unit 640.

In view of the above, based on the architecture of FIG. 8, the command engine 630 processes the enable signal EN, bitblt command COM, and the quantity parameter clip₋num sent by the processor 610 into the bitblt enable signal bitblt_enable and the parameters dir, dst_ba, src_ba, height, and width, and then send them to the bitblt unit 640. As such, when the bitblt enable signal bitblt_enable is valid, the bitblt unit 640 can execute bitblt accordingly.

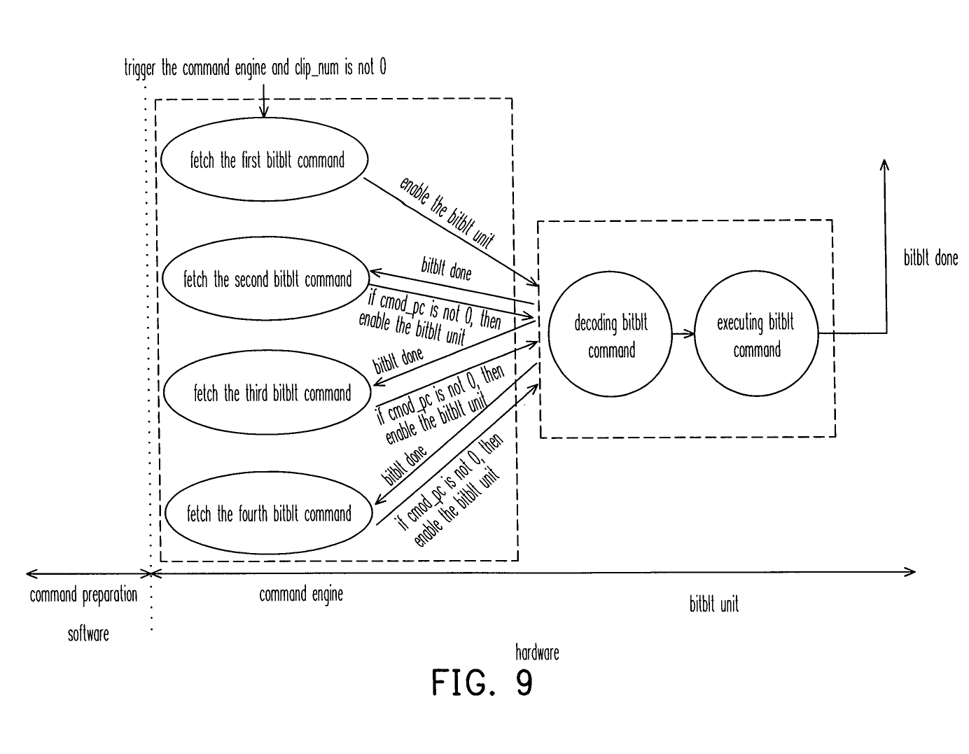

FIG. 9 shows a finite state machine (FSM) according to the first embodiment of the present invention. The command engine is triggered and number of the region(s) to be moved, the parameter clip₋num, is checked whether it is 0. If yes, the command engine will be returned to the standby state; otherwise, the command engine will actively fetch the first bitblt command prepared by the processor. Then the bitblt unit is enabled to execute the first bitblt command accordingly. After the bitblt unit finishes the execution of the first bitblt command, the bitblt unit will return a result (the signal bitblt_done as shown in FIG. 8) to the command engine. If the updated parameter cmod_pc is not 0 after the first bitblt command is executed, which means one or more bitblt commands need to be executed, the command engine will actively fetch the second bitblt command. The bitblt unit will be re-enabled to execute the second bitblt command accordingly. Until the command engine has fetched all the commands, and the bitblt unit has executed all the bitblt commands, the bitblt with clipping-in or clipping-out function is completed. In FIG. 9, the dotted line represents the border line between software components and hardware components, that is, although the preparation command is completed by a physical processor, the processor may not need any dedicated circuit for the command preparation since inherent or new added functions of the processor are enough. However, the command engine is dedicated in the first embodiment of the present invention.

For example, in FIG. 3v, there are four regions to be moved during bitblt with clipping-out, i.e. the regions respectively specified by the coordinates (x0,y0) and (x0+W,tp), the coordinates (x0,tp+1) and (lf,bt), the coordinates (rt,tp+1) and (x0+W,bt), as well as the coordinates (x0,bt+1) and (x0+W,y0+H). Thus, the first bitblt command is executed to move the region represented by the coordinates (x0,y0) and (x0+W,tp). The second bitblt command is executed to move the region represented by the coordinates (x0,tp+1) and (lf,bt). The third bitblt command is executed to move the region represented by the coordinates (rt,tp+1) and (x0+W,bt). The fourth bitblt command is executed to move the region represented by the coordinates (x0,bt+1) and (x0+W,y0+H). As such, the bitblt with clipping-out function is completed by sequentially executing the four bitblt commands.

### Second Embodiment

The schematic view of the architecture according to the second embodiment of the present invention is the same or similar to FIG. 6 of the first embodiment. The difference lies in that the command engine in the second embodiment is implemented in software.

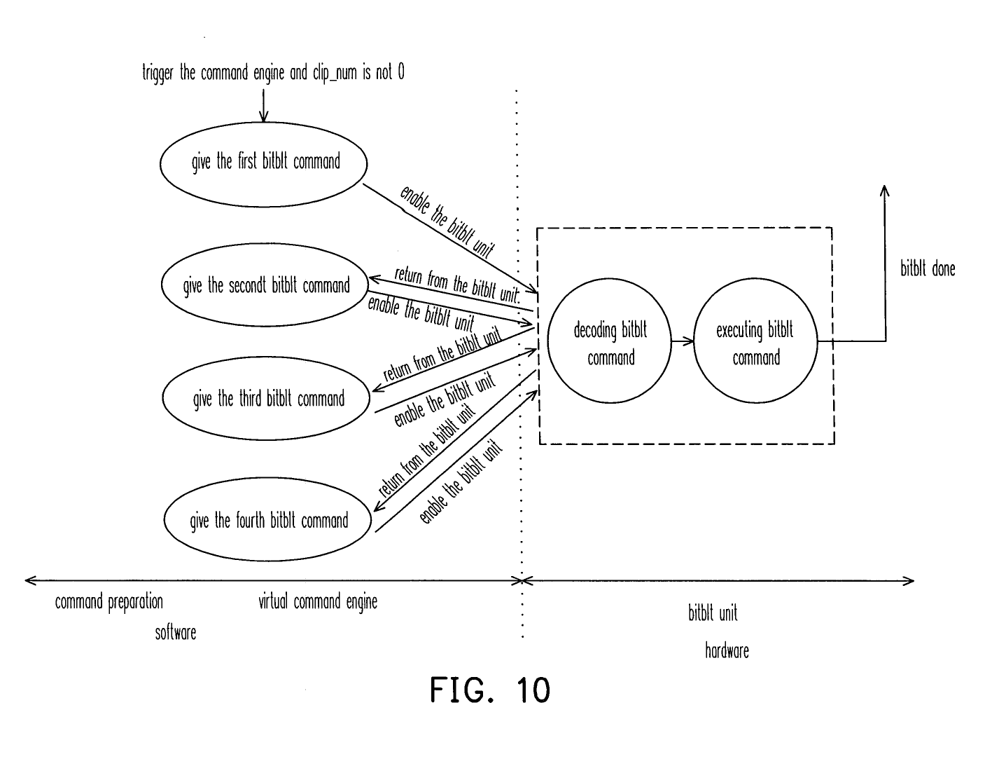

FIG. 10 shows a finite state machine (FSM) according to the second embodiment of the present invention. Firstly, the virtual command engine is triggered and number of the regions to be moved, the parameter clip₋num, is checked whether it is 0. If yes, the virtual command engine will be returned to the standby state; otherwise, the processor will actively give the first bitblt command into one buffer memory within the virtual command engine, wherein the bitblt command is still prepared by the processor. Then, the bitblt unit is enabled to execute the first bitblt command accordingly. After the bitblt unit finishes the execution of the first bitblt command, the bitblt unit will return a result to the command engine. Next, the processor will actively give the second bitblt command into another buffer memory within the virtual command engine. The bitblt unit will be re-enabled to execute the second bitblt command accordingly. Until the command engine has given all the commands, and the bitblt unit has executed all the bitblt commands, the bitblt with clipping-in or clipping-out function is completed.

For example, in FIG. 3v, there are four regions to be moved during bitblt with clipping-out, i.e. the regions respectively specified by the coordinates (x0,y0) and (x0+W,tp), the coordinates (x0,tp+1) and (lf,bt), the coordinates (rt,tp+1) and (x0+W,bt), as well as the coordinates (x0,bt+1) and (x0+W,y0+H). Thus, the first bitblt command means to move the region represented by the coordinates (x0,y0) and (x0+W,tp). The second bitblt command means to move the region represented by the coordinates (x0,tp+1) and (lf,bt). The third bitblt command means to move the region represented by the coordinates (rt,tp+1) and (x0+W,bt). The fourth bitblt command means to move the region represented by the coordinates (x0,bt+1)and (x0+W,y0+H). As such, the bitblt with clipping-out function is completed.

It can be seen from the bottom of FIG. 10 that in the second embodiment, the command preparation and the virtual command engine are completed by the processor, i.e. the command preparation and the virtual command engine are executed by the original or new added functions of the processor. However, the bitblt unit is implemented in hardware. In FIG. 10, the dotted line represents the border line between software components and hardware components.

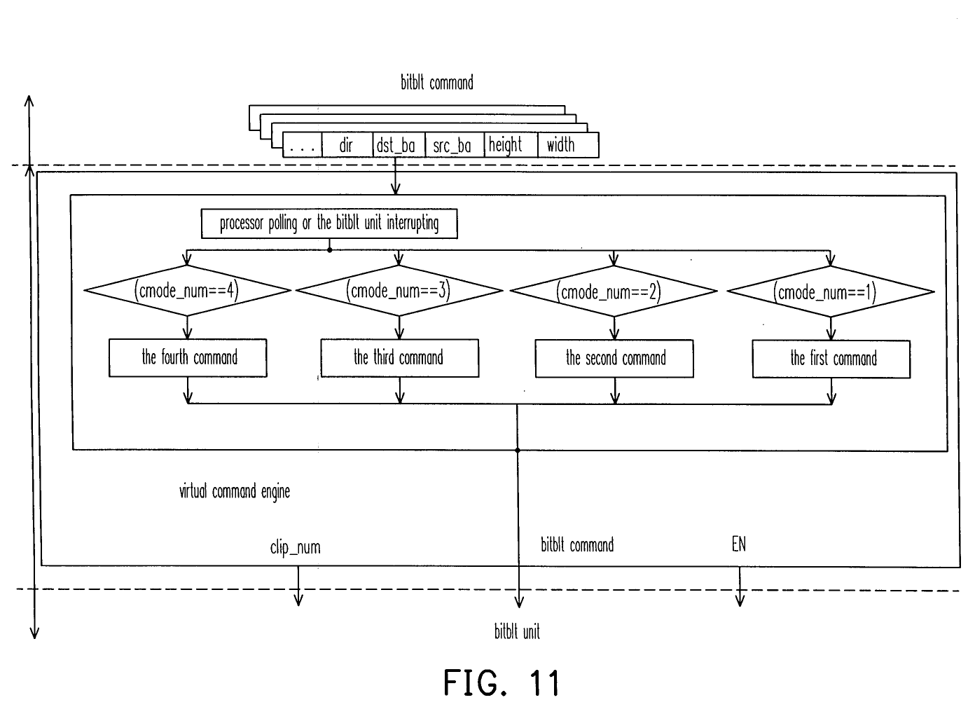

FIG. 11 shows a schematic view of the second embodiment of the present invention. The bitblt commands are prepared by the processor. Then, the processor polls the bitblt unit. If the bitblt unit makes a response, then the processor will give the prepared command to the virtual command engine, and inform the bitblt unit to receive the bitblt command. Alternatively, by sending an interrupt signal to the processor actively, the bitblt unit requests the processor to give the prepared command to the virtual command engine.

And then, the value of the parameter clip-num is read. If the value of the parameter comde_num is 4, the bitblt unit will receive the fourth command stored in one of the buffers, for example the fourth buffer. If the value of the parameter clip₋num is 3, the bitblt unit will receive the third command stored in the third buffer. If the value of the parameter clip₋num is 2, the bitblt unit will receive the second command stored in the second buffer. If the value of the parameter clip₋num is 1, the bitblt unit will receive the first command stored in the first buffer.

Furthermore, the virtual command engine (or the processor) sends the parameter clip₋num and the enable signal EN to the bitblt unit. Thus, the bitblt unit finishes bitblt accordingly.

The processors in the first and the second embodiments of the present invention also can be named as a command preparation unit.

In view of the above, through software and hardware architectures of the first and second embodiments of the present invention, region-based bitblt with clipping-in or clipping-out can be achieved. As such, the disadvantages of the pixel-based check of the conventional art are eliminated.

The difference between the conventional pixel-based bitblt with clipping-in or clipping-out and the region-based bitblt with clipping-in or clipping-out according to the first and second embodiments of the present invention are compared in the following table:

| | pixel-based | Region-based | Region-based |
|---|---|---|---|
| | (conventional) | (software) | (hardware) |
| Area (amount of | About 2000 | 0 | About 3000 |
| transistors) | (0.18 μm) | | (0.18 μm) |
| Performance | Inferior | superior | optimized |
| Complexity | High | low | low |

It can be known form the above table and the descriptions of the embodiments that the conventional pixel-based bitblt with clipping-in or clipping-out only can be implemented in hardware, while the present invention can be implemented both in hardware or software. The reason why the performance of the first embodiment is slightly inferior to that of the second embodiment is that some clock cycles may be wasted when the processor polls the bitblt unit or the bitblt unit interrupts the processor.

The present invention has been disclosed above in the preferred embodiments, but is not limited to those. It is known to persons skilled in the art that some modifications and innovations may be made without departing from the spirit and scope of the present invention. Therefore, the scope of the present invention should be defined by the following claims.

What is claimed is:

1. A device for region-based bitblt with clipping-in or clipping-out, wherein data within a source bitblt region at a first source base address is selectively moved to a destination bitblt region at a first destination base address, comprising:
a command preparation unit, for producing one or more bitblt commands if one or more regions within the source bitblt region are to be moved;
a command engine, including at least a plurality of buffer memories for storing the bitblt commands, for decoding each of the bitblt commands into a second source base address, a second destination base address, a height parameter, and a width parameter; and
a bitblt unit, for bitblting the regions to be moved to the destination bitblt region based on the second source base address, the second destination base address, the height parameter and the width parameter.

2. The device as claimed in claim 1, wherein the command preparation unit determines first to fourth position codes based on a position relationship between a clipping window and the destination bitblt region.

3. The device as claimed in claim 2, wherein the command preparation unit determines a first quantity parameter representative of the number of the regions to be moved and the coordination parameters of the regions to be moved based on the first to the fourth position codes and a clipping type.

4. The device as claimed in claim 3, wherein the command preparation unit generates a command engine enable signal if at least one region of the source bitblt region needs to be bitblted.

5. The device as claimed in claim 4, wherein the command engine further comprises:
a first flip-flop, for registering the command engine enable signal.

6. The device as claimed in claim 4, wherein the command engine further comprises:
a first multiplexer, controlled by a result signal returned from the bitblt unit, for selecting the first quantity parameter or a second quantity parameter as a third quantity parameter;
a second flip-flop, for registering and outputting the third quantity parameter;
an adder, for decrementing the third quantity parameter to generate the second quantity parameter, and then feeding the second quantity parameter back to the first multiplexer; and
a comparator, for comparing the third quantity parameter and a reference value to determine if at least one region of the source bitblt region needs to be bitblted.

7. The device as claimed in claim 6, wherein the command engine further comprises:
a second multiplexer, coupled to the buffer memories, for selecting one of the bitblt commands stored in one of the buffer memories based on the third quantity parameter.

8. The device as claimed in claim 7, wherein the command engine further comprises:
a command decoding unit, for receiving and decoding the bitblt command selected by the second multiplexer, and sending a decoding result to the bitblt unit.

9. The device as claimed in claim 1, wherein the number of the buffer memories is equal to the maximum number of possible bitblt commands.

10. A method for region-based bitblt with clipping-in or clipping-out, wherein data within a source bitblt region at a first source base address is selectively moved to a destination bitblt region at a first destination base address, comprising:
producing one or more bitblt commands if one or more regions within the source bitblt region are to be moved;
storing the bitblt commands;
decoding each of the bitblt commands into a second source base address, a second destination base address, a height parameter, and a width parameter; and
bitblting the regions to be moved to the destination bitblt region, based on the second source base address, the second destination base address, the height parameter and the width parameter.

11. The method as claimed in claim 10, wherein the producing step further comprises:
determining first to fourth position codes based on a position relationship between a clipping window and the destination bitblt region;
determining a quantity parameter representative of the number of regions to be moved and coordination parameters of the regions to be moved based on the first to fourth position codes and a clipping type; and
generating the one or more bitblt commands according to the quantity parameter and the coordination parameters of the regions to be moved.

12. The method as claimed in claim 11, wherein the bitblting step is enabled if at least one region of the source bitblt region needs to be bitblted.

13. The method as claimed in claim 10, wherein the decoding step further comprises:
a) loading the bitblt commands into a plurality of buffer memories;
b) selecting a bitblt command sequentially; and
c) extracting from the bitblt command to obtain the second source base address, the second destination base address, the height parameter and the width parameter.

14. The method as claimed in claim 13, wherein the buffer memories are sufficient to store the maximum number of possible bitblt commands.
